(19) United States
(12) Patent Application Publication
(10) Pub. No.: US 2021/0310210 A1
(43) Pub. Date: Oct. 7, 2021

(54) SECURED SERVICE COVER ASSEMBLY

(71) Applicant: RAM Canada Rapid Access Management Inc., Candiac (CA)

(72) Inventor: Brian Joseph Payne, Candiac (CA)

(21) Appl. No.: 17/224,991

(22) Filed: Apr. 7, 2021

Related U.S. Application Data
(60) Provisional application No. 63/006,606, filed on Apr. 7, 2020.

(51) Int. Cl. E02D 29/14; E05B 47/00; E05C 1/06

(52) U.S. Cl. CPC E02D 29/1427; E05C 1/06; E05B 47/0012; E02D 29/1481

(57) ABSTRACT

A service cover assembly with a locking mechanism is provided. The assembly includes a cover plate with a first and second side, and a through-hole connecting the two sides. A main cylinder with a hollow interior is attached at a first end to the first side of the cover plate and is positioned to align the hollow interior with the through-hole. A pinion gear system is located at a second end of the main cylinder. A plurality of securing rod is provided, each rod positionable in a secured or unsecured position with the pinion gear system. At least one access barrier is disposed within the main cylinder and/or the pinion gear system to restrict access and/or operation of the pinion gear system. One of the at least one access barrier is a lock disposed within the hollow interior of the main cylinder.

### FIELD OF INVENTION

The present disclosure relates generally to service covers, and more particularly to a service cover assembly with a locking mechanism.

### BACKGROUND

Service covers such as manhole covers are coverings that cover an access opening into an encasement such as a sewer, tunnel, utility vault, conduit or similar structures. These structures may be used to transport fluid (in the case of a sewer or tunnel) or provide a protective space for various utilities including, but not limited to, water pipes and valves, gas pipes and valves, communication cables, electrical cables or other equipment.

The service cover generally sits or rests on a head or “crown” of the encasement. These structures are generally located on a ground surface or a road surface. Accordingly, these service covers act as protective covers for the encasement and their removal provides an access route for an authorized service person to enter the encasement to perform scheduled inspection and service work on the utilities provided within or permit emergency personnel to access the utilities during an emergency event.

Service covers designed to cover access passages such as manholes are typically configured to comprise a metallic plate-like body with four (4) to six (6) small square holes extending between opposing faces of the body to provide a means of removal. A service person can remove the service cover using a dirt pick or a similar tool to lift the cover from the crown by inserting the pick into one of the four to six small square holes.

Conventional service covers are therefore easily removed by anyone with a dirt pick, so that access to the utilities within the encasement cannot be controlled. Some conventional service covers can include a mechanism that secures the service cover to the crown. However, these mechanisms may be bypassed or compromised with little effort. The ease of removal of a service cover makes the covers themselves a target for theft as the service cover can be sold as valuable scrap metal, and invites trespassers to access the utilities within the encasement. It may be appreciated that intentional or accidental disablement of the utilities may result in undesirable disruptions to essential services such as the supply of electricity, gas and water, and communication services such as telephone and Internet connectivity.

Explosions within the encasement may cause the service cover to be ejected from the crown in an unexpected and uncontrolled manner, potentially injuring nearby persons or damaging nearby property. The exposed opening to the encasement such as a manhole also becomes a danger for vehicles and pedestrians.

As such, there is a need for solutions for addressing or ameliorating at least some of the problems identified above.

### SUMMARY OF THE DISCLOSURE

In general, the present specification describes a service cover with a locking mechanism.

According to one aspect, there is provided a service cover assembly that includes a cover plate with a through-hole and a main cylinder with a hollow interior attached to the cover plate and positioned to align the hollow interior with the through-hole. A pinion gear system is attached to the main cylinder, the pinion gear system being accessible and operable by a user of the service cover assembly through the through-hole and the hollow interior. Also provided is a plurality of securing rods operatively coupled to the pinion gear system, and at least one access barrier disposed within the main cylinder to restrict access and operation of the pinion gear system through the through-hole.

According to another aspect, there is provided a locking mechanism for securing a service cover to a corresponding service cover crown, the locking mechanism includes a main cylinder with a hollow interior and respective first and second openings at a first end and a second end of the main cylinder, the main cylinder being attachable to the cover plate at the first end. Also provided is a pinion gear system attached to the second end of the main cylinder and accessible through the hollow interior and operable to position securing rods to secure the service cover to the service cover crown. At least one access barrier is disposed within the main cylinder to restrict access and operation of the pinion gear system through the first opening.

Additional aspects of the present invention will be apparent in view of the description which follows.

### BRIEF DESCRIPTION OF THE DRAWINGS

Features and advantages of the embodiments of the present invention will become apparent from the following detailed description, taken with reference to the appended drawings in which:

FIGS. 1A and 1B (collectively, FIG. 1) are plan and cross-sectional views, respectively, of a service cover assembly according to at least one embodiment of the invention;

FIG. 2 is a cross-sectional view of a locking mechanism of the assembly of FIG. 1;

FIGS. 3A and 3B are perspective views of a main cylinder according to at least one embodiment of the invention;

FIGS. 3C and 3D are perspective views of a tamper pattern cap according to at least one embodiment of the invention;

FIGS. 4A to 4D (collectively, FIG. 4) are plan views of a lock configurations usable with the locking mechanism of FIG. 2;

FIG. 5A is a perspective view of an allen pattern gear usable with the service cover assembly of FIG. 1;

FIG. 5B is a perspective view of a securing rod usable with the service cover assembly of FIG. 1;

FIG. 5C is a plan view of a removal tool usable to remove the service cover assembly of FIG. 1; and

FIG. 6 is a cross-sectional view of a crown for use with the service cover assembly of FIG. 1.

### DETAILED DESCRIPTION

The description which follows, and the embodiments described therein, are provided by way of illustration of examples of particular embodiments of the principles of the present invention. These examples are provided for the purposes of explanation, and not limitation, of those principles and of the invention.

The embodiments herein disclose a service cover assembly with an improved locking mechanism to keep the service cover locked to a corresponding crown associated with an access route to utilities and equipment that are provided in an encasement. Securing the service cover in this manner provides access control to the utilities and equipment. The contemplated utilities support government services, financial services, emergency services and the general public. More specifically, the disclosed service cover assembly is intended to be usable to prevent unauthorized access, removal, theft, tampering or the destruction of utilities and equipment within the encasement that may be detrimental to the well-being of a community, a region, and/or the nation as a whole.

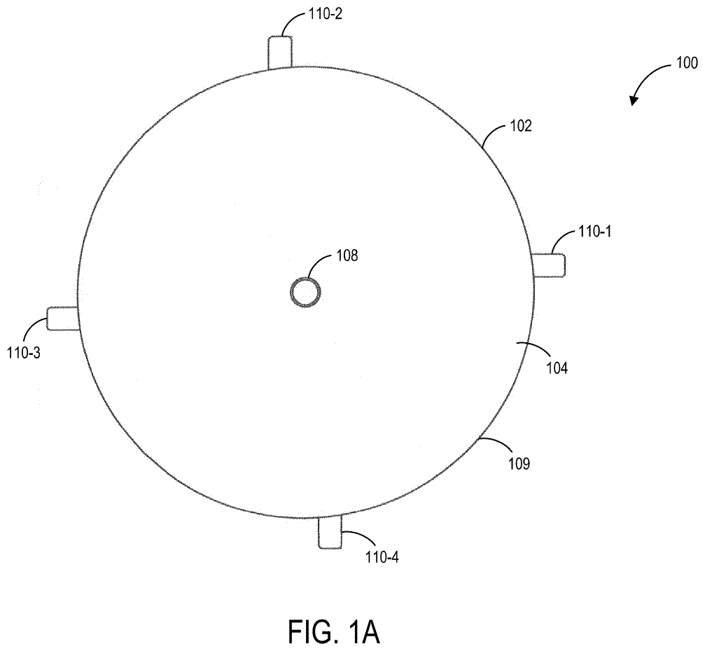

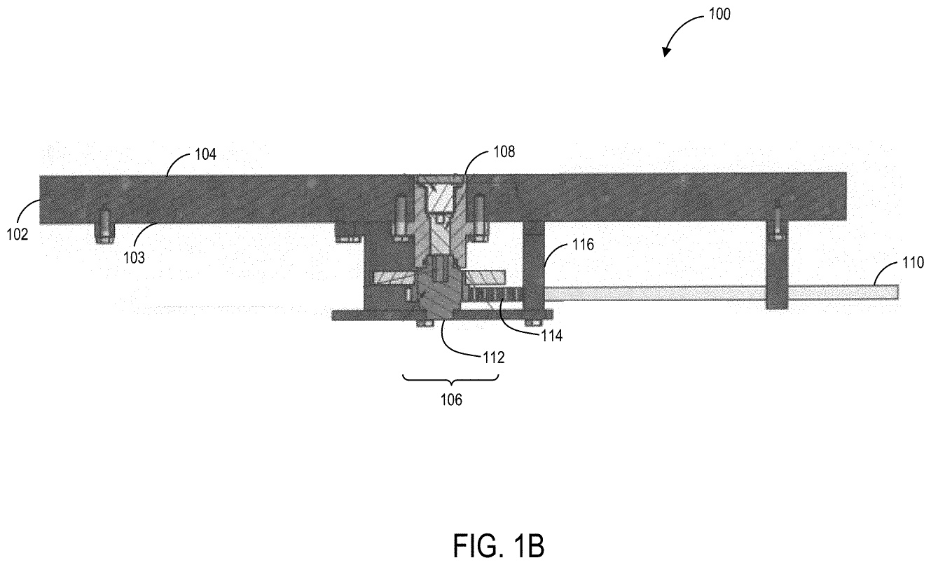

Referring first to FIGS. 1A and 1B (collectively, FIG. 1), shown therein are plan and cross-sectional views, respectively, of a service cover assembly (the “assembly”) 100 according to at least one embodiment of the invention. While the disclosed embodiment is used in connection with a manhole, it may be adapted or configured for use with other types of encasement openings.

The assembly 100 includes a number of access barriers in which each barrier is intended to discourage unauthorized removal of the assembly 100 from the crown. In the illustrated embodiment, the assembly 100 includes a circular cover plate 102, a set of slidable securing rods 110-1 to 110-4 (collectively, 110), and a locking mechanism 106, as shown in FIG. 1B, attached to one side of the cover plate 102 via a support frame 116. The locking mechanism 106 includes a gear pinion system 112 operatively engaged with the securing rods 110 to move the securing rods 110 so as to engage or disengage them from the crown. As described more fully below, the gear pinion system 112 can be accessed and operated by an authorized service person through a port 108 provided on the cover plate 102. Also described more fully below, the access barriers provided within the locking mechanism are intended to restrict access to and/or operation of the gear pinion system 112 and thereby restrict the ability of an unauthorized user from disengaging the securing rods 110 and to remove the assembly 100 from the crown.

The cover plate 102 can be made of any suitable rigid material. In the present embodiment, the cover plate can be made using a malleable metal such as cast iron. The surface of the cover plate 102 on which the locking mechanism 106 is attached can be regarded as the “inside” surface 103 that faces the encasement or access path to said encasement. The opposite “outside” surface 104 of the cover plate 102 is intended to face an environment external to the encasement. It is noted that in the present embodiment, the outside surface 104 of the cover plate 102 does not include standard holes for removal using a dirt pick. The lack of such holes prevent tampering and/or removal of the cover plate 102 using easily available tools. Instead, the cover plate 102 includes a port 108, which in the illustrated embodiment has a through-hole defined therethrough. As described more fully below, the port 108 can be sized to accommodate a portion of the locking mechanism 106. The access barriers within the locking mechanism can be disengaged one by one via the port 108 to permit access to and operation of the pinion gear system 112. Operation of the pinion gear system 112 allows the assembly 100 to be unlocked for removal. An authorized user may access the gear pinion system 112 to lock and unlock the assembly 100 from the crown through the port 108.

In the present embodiment, the securing rods 110 are positionable in an engaged (i.e. “secured”) position or a disengaged (i.e. “unsecured”) position. More specifically, the gear pinion system 112 is operable to slide the securing rods 110 to the secured position so that each of the securing rods 110 extend outwardly beyond a perimeter 109 of the cover plate 102, as shown in FIG. 1A. A suitable tool, as described more fully below, may be used to provide the necessary rotational movement to the gear system to drive the securing rods 110 to one of the secured and unsecured positions. When the cover plate 102 is positioned on the crown of a manhole (see e.g., crown 600 of FIG. 6 as described more fully below), the securing rods 110 in the secured position extend past the perimeter 109 of the cover plate 102 and into a corresponding receptacle (see e.g., receptacle 620 of FIG. 6 and described more fully below) so that an attempt to lift the cover plate 102 away from the crown is restricted by the engagement of each securing rod 110 with its respective receptacle. However, when the securing rods 110 are in the unsecured position, they no longer extend beyond the perimeter 109 of the cover plate 102. In the unsecured position, the securing rods 110 do not engage with their respective receptacles thereby permit removal of the cover plate 102 from the crown.

As noted above, access to or operation of the gear pinion system 112 can be restricted by incorporating a plurality of access barriers. As described more fully below, the access barriers may include a tamper seal, a pattern cap and a high-security lock provided in the locking mechanism 106 to restrict access to operation of the gear pinion system 112 through the port 108. Further access barriers include an allen pattern gear provided to the gear pinion system 112, intended for use by the authorized user to operate the gear pinion system 112. Engagement of the allen pattern gear requires a corresponding specialized tool to limit/restrict operation of gear pinion system 112. As the pinion gear system 112 is accessible externally through the port 108, these access barriers may be positioned between the port 108 and the gear pinion system 112 to increase the difficulty for an unauthorized user to access and operate the gear pinion system 112. This arrangement therefore improves the security of the overall assembly 100 by allowing the assembly 100 to be easily installed or removed but difficult to unlock by those without the proper tools. In some embodiments, all of the access barriers would need to be disengaged before the gear pinion system 112 is accessible or operable. An authorized individual would be provided with the necessary tools and/or credentials to disengage each access barrier, while an unauthorized individual may not. Accordingly, the deployment of multiple access barriers is intended to deter unauthorized access by significantly increasing the amount of effort required for the unauthorized individual to remove the assembly 100, as doing so requires that individual to circumvent each access barrier through the port 108.

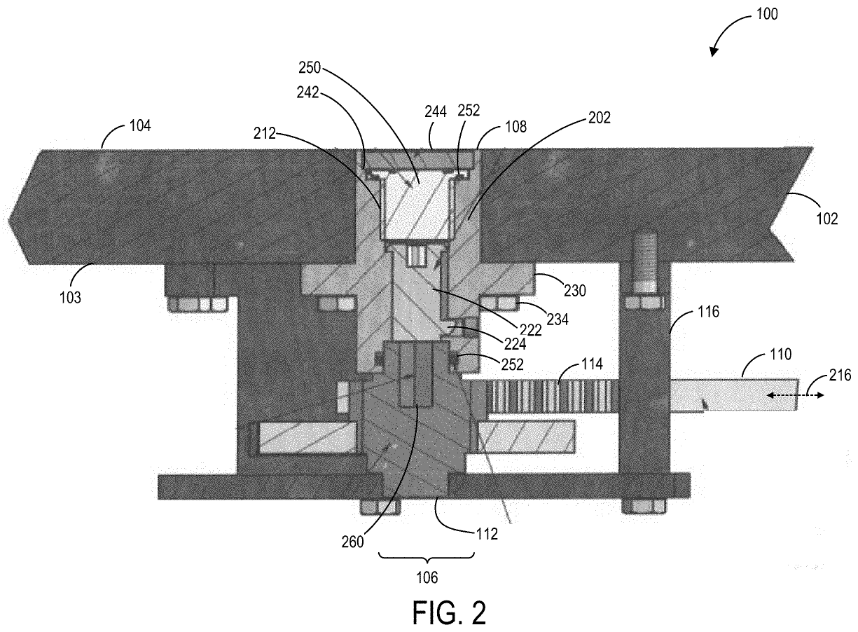

Referring now to FIG. 2, shown therein is a close-up of the cross-sectional view of FIG. 1A showing the locking mechanism 106, the pinion gear system 112 and the plurality of access barriers in greater detail.

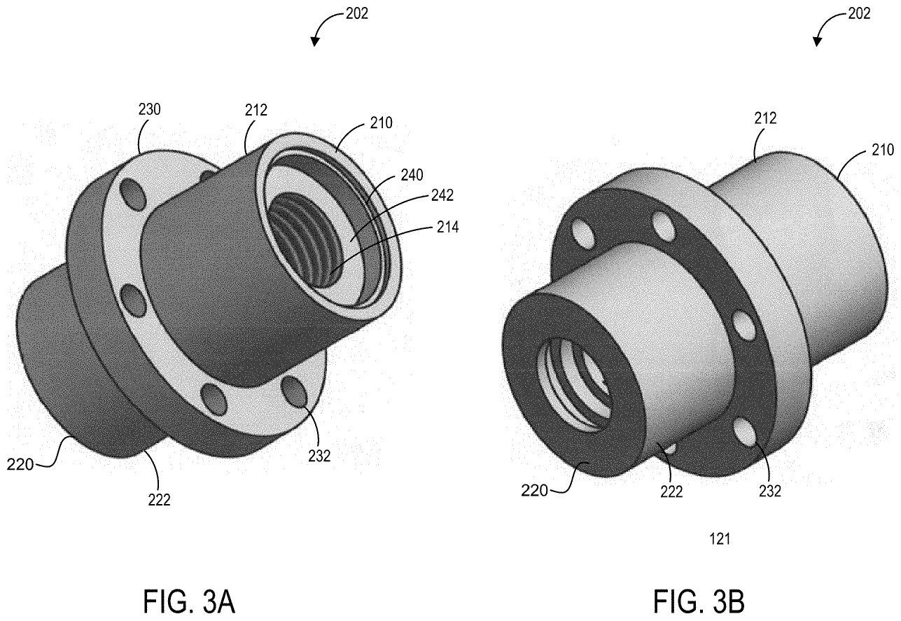

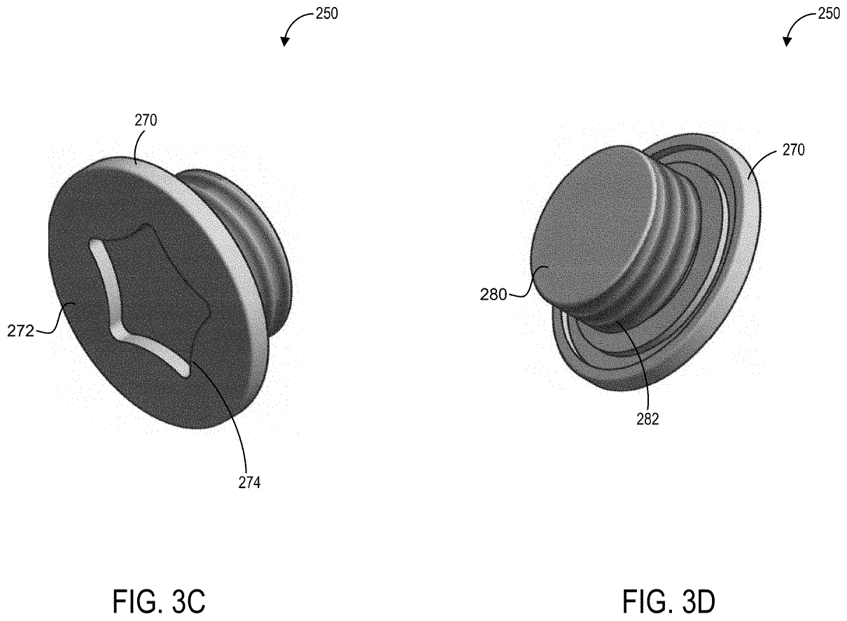

The locking mechanism 106 includes a main cylinder 202 with a hollow interior. Openings are provided at each end of the cylinder 202. FIGS. 3A and 3B depict perspective views of one embodiment of the main cylinder 202 in greater detail from a corresponding first end 210 and second end 220, respectively. As shown in FIGS. 3A and 3B, the main cylinder 202 can be divided into a first chamber 212 (shown in FIG. 3A) and a second chamber 222 (shown in FIG. 3B). In the present embodiment, the hollow interior overlaps or aligns with the port 108 of the cover plate 102 (illustrated more clearly in FIG. 2) to enable an authorized user to access the first and second chambers 212 and 222 through the port 108. Also in the present embodiment, each of the chambers may be delineated based on the differences in their respective diameters. As shown in FIG. 2, the first chamber 212 has a slightly wider diameter than the second chamber 222. In other embodiments, the first and second chambers 212 and 222 may be delineated using the position of a geometric midpoint of the longitudinal axis of the main cylinder 202. In yet other embodiments, the point of separation may be a position other than the midpoint.

Referring still to FIG. 2, in the present embodiment, a portion of the main cylinder 202 corresponding to the first chamber 212 is positioned into the through-hole of the port 108 in cover plate 102. A lip portion 230 that extends radially from the main cylinder 202 abuts the inside surface 103 of the cover plate 102. As shown in FIG. 3, one or more attachment holes 232 can be defined through the lip portion 230 to receive fasteners such as threaded bolts with bolt heads 234 having diameters greater than those of the attachment holes 232. Such fasteners can be configured to attach to the cover plate 102 to affix the main cylinder 202 thereto.

The lip portion 230 can be positioned along the main cylinder 202 so that the length of a portion of the main cylinder 202 that is positioned in the port 108 equals or substantially equals a thickness of the cover plate 102. This arrangement allows the first end 210 of the main cylinder 202 to be flush or substantially flush with the outside surface 104 of the cover plate 102 to maintain a planar or substantially planer outside surface 104 as shown in FIG. 2.

Referring to FIG. 3A, the first end 210 of the main cylinder includes a recess 240 that defines a circumferential platform 242. In the present embodiment, the recess 240 is configured to receive a tamper seal 244 (see FIG. 2) at the outside face 104 of the cover plate 102 to occlude the opening of the main cylinder 202 at the first end 210. The tamper seal 244 effectively closes off the port 108 and can be regarded as a first access barrier of the plurality of access barriers. Once installed, the tamper seal 244 restricts access to the first chamber 212 and therefore also restricts access and operation to the gear pinion system 112. The tamper seal 244, once positioned into the recess 240 may be flush with the outside surface 104 of the cover plate 102 as shown in FIG. 2.

In certain embodiments, the tamper seal 244 can be designed as a single-use seal. The tamper seal 244 must be broken to gain access to the first chamber 212. The tamper seal 244 may be made with a suitable material such as polycarbonate plastic that may be broken but cannot be re-assembled back to its original (i.e. unbroken) state. In general, the tamper seal 244 is designed in such a way that only an authorized user is able to replace the seal in the recess 240. Accordingly, a broken or missing tamper seal 244 may provide a point of inspection or immediate visual verification that is indicative of tampering or unauthorized access. In other embodiments, the tamper seal 244 can be numbered with a unique identifier such as a serial number to provide additional security. Administrators may log or store a list of known unique identifiers associated with the tamper seals 244 currently in use. For example, whenever a new tamper seal 244 is used to replace an old seal, the list may be updated to include the identifier of the new seal, while the identifier entry for the old seal may be removed or flagged as “expired” or “no longer in use”. During inspections, the identifier of the tamper seal can be verified against the list of identifiers to confirm that it is in use. Where the identifier does not match any of the list of known identifiers in use or an identifier is missing from the tamper seal, such observations may be indicative of tampering or unauthorized access.

The first chamber 212 of the main cylinder 202, as shown in FIG. 2, may be used to receive a tamper pattern cap 250. The tamper pattern cap 250 may be configured to attach securely to the first chamber 212 so that the authorized user must use a corresponding removal tool to remove the tamper pattern cap 250 to gain access to the second chamber 222. The tamper pattern cap 250 can be fabricated using a suitably durable and corrosion-resistant material including, but not limited to, stainless steel. FIGS. 3C and 3D depict perspective views of an example embodiment of the tamper pattern cap 250 that can be installed into the first chamber 212. As shown in FIG. 3C, the tamper pattern cap 250 includes cap portion 270 having a surface 272 with a pattern 274 provided thereon for engagement using the corresponding removal tool. The pattern 274 of the present embodiment is a five-point star. A corresponding removal tool with a corresponding structure that mates with the pattern cap is needed to engage the pattern cap 250. It would be understood that other shapes of varying complexities can be used. Once installed, the cap 270 portion rests on the platform 242 of the main cylinder 202.

The manner of securement of the tamper pattern cap 250 to the first chamber 212 can be accomplished using a suitable technique. For example, mechanical securement, magnetic securement, or a combination or magnetic and mechanical securement approaches can be employed. In the present embodiment, for example, a shaft portion 280 of the tamper pattern cap 250 is provided with a threaded surface 282 as shown in FIG. 3B to engage with corresponding threads 214 provided on the inner surface of the first chamber 212. The tamper pattern cap 250 can be secured to the first chamber 212 using this threaded connection. A specially configured tool may be used to screw and unscrew the tamper pattern cap 250 for installation and removal.

In view of the foregoing, the tamper pattern cap 250 can be regarded as another access barrier of the plurality of access barriers. In the present embodiment, the tamper pattern cap 250 can be regarded as the second access barrier operable to restrict access to or operation of the gear pinion system 112 through the port 108.

Disengagement or removal of the tamper pattern cap 250 provides access to the second chamber 222 of the main cylinder 202 of FIG. 2. The second chamber 222 may be configured to receive another access barrier (i.e. the third access barrier of the plurality of access barriers) that restricts access to or operation of the gear pinion system 112 through the port 108. In the present embodiment, the barrier comprises a lock (e.g. mechanical, electronic, or electro-mechanical) that is secured to the second chamber 222 when it is in a locked position and removable from the second chamber 222 when unlocked with a corresponding key or other access credential.

Correspondingly, the structure of the second chamber 222 can be designed to accommodate the form factor of the lock to enable securement. The arrangement and positioning of access barriers within the main cylinder 202 improves the tampering resistance of the assembly 100 by requiring the user to disengage each of the access barriers to access the pinion gear system 112 through the port 108.

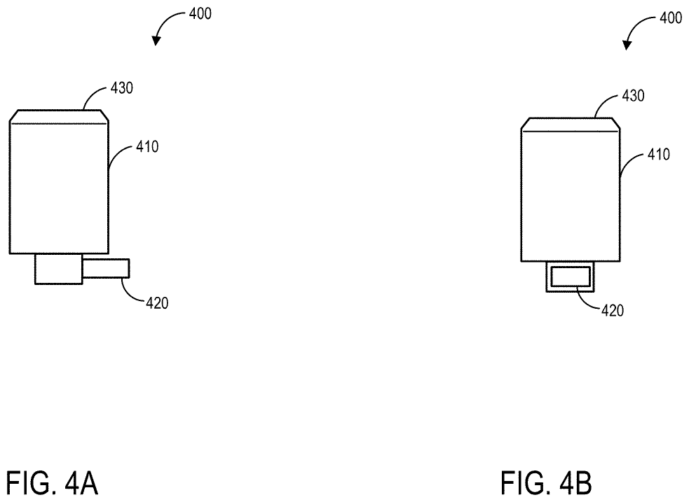

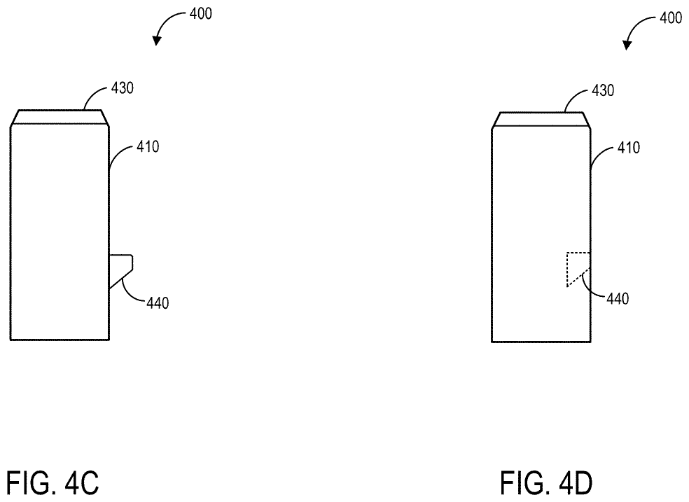

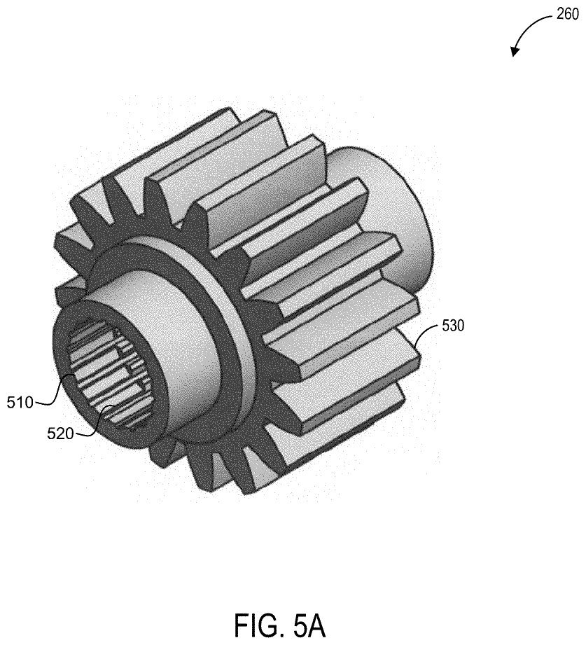

For example, a cylindrical or tube-shaped lock 400 as shown in FIGS. 4A and 4B may be used. In the illustrative embodiment, the lock 400 is a cam lock that includes a main body 410 and a cam 420 that is rotatable about the main body 410. FIG. 4A shows the cam 420 in a first position and FIG. 4B shows the same cam 420 in a second position rotated 90 degrees from the first position. The lock 400 includes a first end 430 for receiving a key to rotate the cam 420 to engage (i.e. lock) or disengage (i.e. unlock) the lock 400.

When the lock 400 is positioned inside the second chamber 222 and in the engaged or locked state, the cam 420 extends into a corresponding receptacle 224 shown in FIG. 2. In this state, the lock 400 cannot be pulled or removed from the second chamber 222 as the cam 420 is latched to the receptacle 224. Therefore, the presence of the lock 400 blocks access to or operation of the pinion gear system 112. When the lock 400 is disengaged or placed in the unlocked state, the cam 420 is rotated into a position that aligns with a recess in the second chamber 222 (not shown) that accommodates the cam 420 so that it is no longer extended into the receptacle 224. In this state, the lock 400 can be pulled out of the second chamber 222 to allow access to the pinion gear system 112 through the port 108.

In an alternative embodiment, shown in FIGS. 4C and 4D, the lock 400 includes a main body 410 and a retractable bolt 440 instead of the cam 420. FIG. 4C shows the bolt 440 in an extended position and FIG. 4D shows the same bolt 440 in a retracted position. The first end 430 of the lock 400 receives a key to engage (i.e. lock) or disengage (i.e. unlock) the lock 400. Engaging or disengaging the lock 400 causes the bolt 420 to extend or retract, respectively.

When the lock 400 is positioned inside the second chamber 222 and in the engaged or locked state, the bolt 440 extends into a corresponding receptacle 224 shown in FIG. 2. In this state, the lock 400 cannot be pulled or removed from the second chamber 222 as the bolt 440 is latched to the receptacle 224. Therefore, the presence of the lock 400 blocks access to or operation of the pinion gear system 112. When the lock 400 is disengaged or placed in the unlocked state, the bolt 440 is retracted into the body 410 so that it is no longer extended into the bolt receptacle 224. In this state, the lock 400 can be pulled out of the second chamber 222 to allow access to the pinion gear system 112 through the port 108.

Examples of locks that can be used include, but are not limited to, cam locks and T-handle locks from vendors such as Abloy™ (e.g. the CLL130T cam lock, or CL290 or CL291 T-Handle lock) or Mul-T-Lock™. High security locks that are difficult to pick or compromise can be used to increase the effort required to disengage the lock. For example, locks employing enhanced locking mechanisms such as the PROTEC2™ technology from Abloy™ or similar advanced locking systems from other vendors can be considered.

In some embodiments, the second chamber 222 can be made to provide a liquid tight environment to enable the lock 400 to be submerged in a suitable liquid such as heavy mineral oil to protect the mechanical components of the lock 400 from damage such as by corrosion from exposure to moisture. Suitable sealing mechanisms such as O-rings 252 can be employed at the second end 220 to provide liquid separation to maintain the heavy mineral oil within the second chamber 222. Similarly, in some embodiments, the pattern cap can also be used to establish a liquid tight first chamber 212 to further limit exposure of the lock 400 to moisture, for example, by restricting movement of moisture from the first chamber 212 to the second chamber 222.

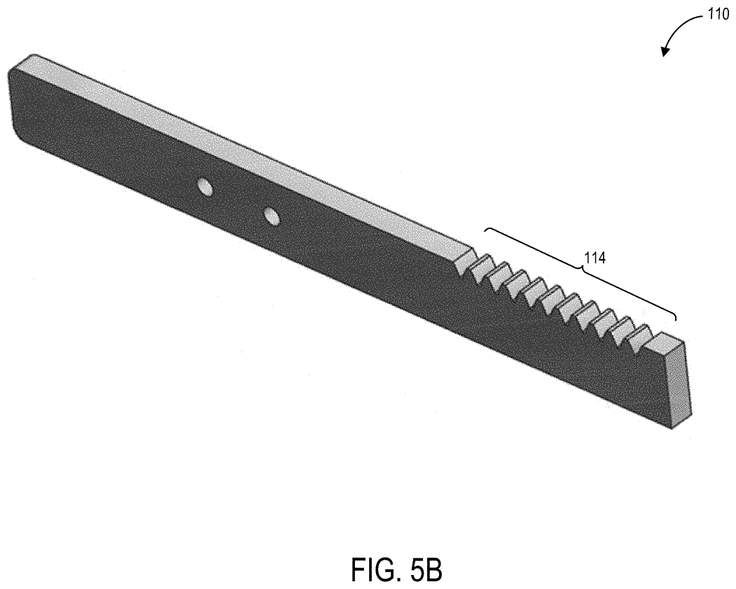

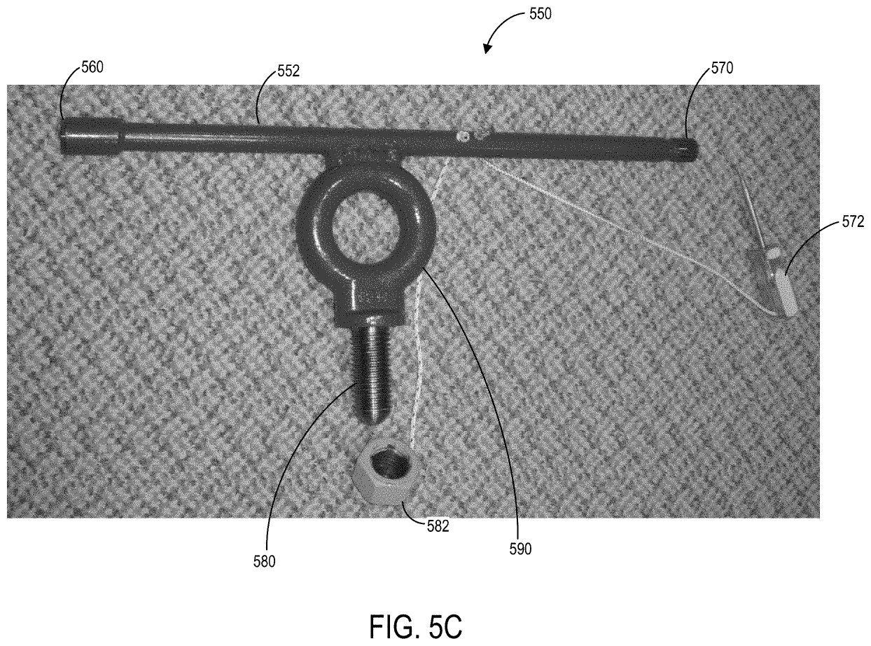

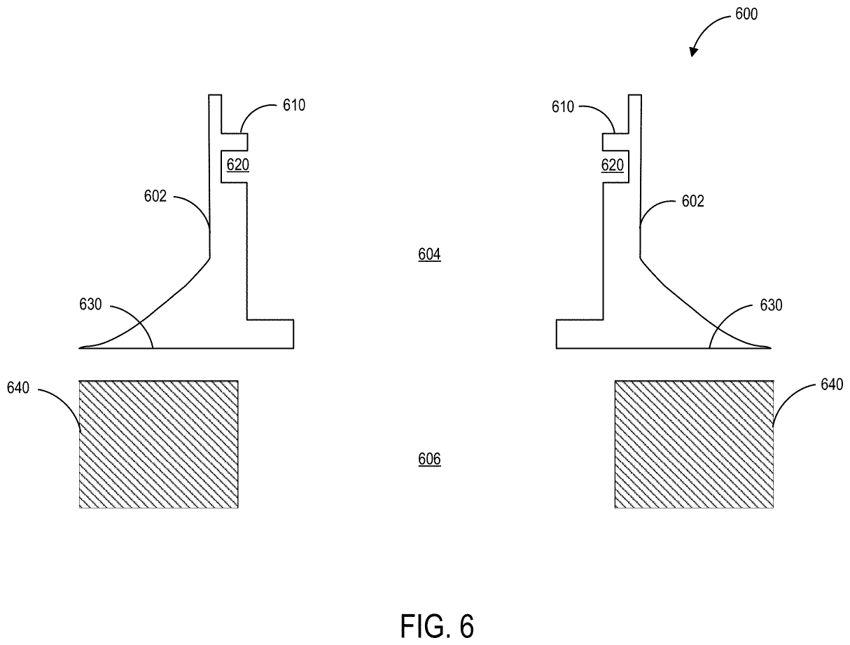

As noted above, unlocking and removal of the lock 400 provides access to the pinion gear system 112. Also noted previously, the pinion gear system 112 is operable to move the securing rods 110 from the secured position to the unsecured position to permit removal of the assembly 100 from the crown. In the illustrated embodiment of FIG. 2, the pinion gear system 112 includes a tamper-proof allen pattern gear 260. FIG. 5A depicts an example of the allen pattern gear 260. As shown in the depiction, the allen pattern gear 260 includes a chamber 510 with a splined internal wall 520. Externally, there is a plurality of gear teeth 530 for engagement with other components of the pinion gear system 112 such as a rack gear 114 as described more fully below. The authorized user may be provided with a specifically designed mechanical drive shaft insertable into the chamber 510 of the allen pattern gear 260 through the port 108 so that manual rotations of the drive shaft causes rotational movement of the allen pattern gear 260 to rotate about its rotational axis. In the present embodiment, the drive shaft may be splined to mate with the splined internal wall 520 of the chamber 510. The spline pattern may be selected to discourage or prevent operation without the proper tool. As such, the configuration of the allen pattern gear 260 acts as another access barrier (i.e. the fourth of the plurality of access barriers) to restrict operation of the pinion gear system 112.

Rotational movement of the allen pattern gear 260 in turn drives a pinion gear (not shown) within the pinion gear system 112 that engages with a rack gear 114 disposed on a portion of the securing rods 110 (the latter is shown in FIGS. 1 and 2 and in greater detail in FIG. 5B). The rack gear 114 converts the rotational movement of the pinion gear into linear sliding movement of the securing rods 110 along its longitudinal axis as indicated by double-headed dashed line 216 of FIG. 2 indicating the possible directions of movement. In the present embodiment, rotating the pinion gear in one direction about 90 degrees moves the securing rods 110 into their corresponding receptacles and places the securing rods 110 in the secured position. Rotating about 90 degrees in the opposing direction places the securing rods in the unsecured direction by moving the securing rods 110 away from their corresponding receptacles.

Upon unsecuring the assembly 100, the entire assembly 100 including the cover plate 102, can be removed from the crown. In the present embodiment, the cover plate 102 may be designed or configured so that removal is accomplished using a specialized removal tool. An example removal tool 550 is shown in FIG. 5C. The tool includes a main member 552 with a key portion 560 at one end for engaging the pattern 274 of the of the tamper pattern cap 250 for installation or removal. At a second end of the main member 552 is a splined portion 570 for engaging the splined internal wall 520 of the allen pattern gear 260 for controlling the securing rods 110. Extending from the main member 552 is a threaded portion 580 for engaging the threads 214 provided on the inner surface of the first chamber 212 as a way to lift the cover plate once the securing rods are disengaged. In the present embodiment, a protective cap 582 can be attached to the threaded portion 580 using a suitable manner (e.g. by friction fit or screw-on fit) to protect the threads from damage when it is not in use. Additionally a punch device 572 can be included for breaking the tamper seal 244.

During use, the punch device 572 is used to break the tamper seal 244 to access the tamper pattern cap 250. The key portion 560 engages the pattern 274 of the tamper pattern cap 250 to enable its removal from the first chamber 212. Once the lock 400 is removed from the second chamber 222, the splined portion 570 of the removal tool 550 is inserted into the allen pattern gear 260 to disengage the securing rods 110 by turning the removal tool 550 in the appropriate direction. The threaded portion 580 of the removal tool 550 is then attachable to the assembly 100 by screw-on engagement with the previously described threads 214 disposed on the inner surface of the first chamber 212 through the port 108. The main member 552 can be used as handle bars to screw or unscrew the threaded portion 580 into the first chamber 212. The entire assembly 100 can be elevated from the crown using the removal tool for removal, for example, by lifting the main member 552. The removal tool 550 can further include an eye bolt 590 positioned between the threaded portion 580 and the main member 552 to enable a hook or loop to be attached. This hook or loop can be connected to a suitable lifting machine to lift the entire assembly 100. This feature may be useful if the assembly 100 is too heavy to be lifted manually. It may be appreciated that the need to use a special removal tool to remove the assembly 100 from the crown can be regarded as yet another access barrier (i.e. the fifth barrier) of the plurality of access barriers.

Referring now to FIG. 6, shown therein is a cross-sectional view of an exemplary crown or head 600 into which the assembly 100 can be installed and secured. The crown 600 itself can be deployed or installed at suitable locations such as the surface of a roadway using techniques known to those skilled in the art. A body portion 602 of the crown 600 has an opening 604 defined therethrough that provides an access path to an encasement 606. A ledge 610 is provided at one end of the body portion 602 for placement of the cover plate 102 of the assembly 100. As shown in FIG. 6, the ledge 610 may extend into the opening 604 to provide a surface for receiving the cover plate 102.

In the illustrated embodiment, the bottom surface of ledge 610 defines one wall of a receptacle 620 for receiving the securing rods 110 of the assembly 100. In the secured position, the securing rods 110 may be extended into the receptacle 620 to resist lifting or removal of the assembly 100. For example, as an unauthorized user attempts to lift the cover plate 102 away from the crown, each of the plurality of securing rods 110 engages with the wall of the respective receptacle to resist further lifting. In some embodiments, the receptacle 620 includes sufficient vertical space to allow some vertical displacement of the assembly 100 so that if there is an explosion inside the encasement 606, the cover plate 102 can be elevated high enough to release any pressure and/or gases from the encasement 606 while still being maintained in the secured position. A foundation portion 630 of the crown 600 enables the installation of the crown 600 over a substrate 640 such as the cement or other materials.

In some implementations, additional access barriers in addition to the five access barriers described above are incorporated into assembly 100. These additional access barriers can incorporate additional access control technologies to deter unauthorized removal by increasing the difficulty and effort imposed on the unauthorized user to remove the assembly 100 from the crown 600. For example, certain electronic monitoring or time-based access schemes can be incorporated into the assembly. In some embodiments, the mechanical high-security lock 400 installed within the second chamber 222 can be further enhanced using electronic components to implement an electronically programmable access control system that provides auditing functionalities.

One such system includes the CLIQ™ access control system used in conjunction with locks from Assa Abloy™ and other manufacturers. Locks incorporating CLIQ™ technology restrict access to the lock's mechanical cylinder components required to disengage a particular lock if a key or master key (that would otherwise be able to operate the mechanical cylinders) is not programmed or authorized for disengaging that lock. This manner of control may be regarded as another access barrier.

The master key is controllable or programmable using a key captive device or decoder installed in a service vehicle to provide controlled and preauthorized access to the appropriate lock and the corresponding encasement 606 to authorized users such as technical and emergency services personnel. During use, whenever a key is inserted into a lock such as lock 400 enhanced with CLIQ™, the interaction and its result (e.g. whether access was permitted or denied, and the identification of the key) are recorded along with a time and date stamp. This access record is stored in both the key and lock enabling an administrator to monitor access to any assembly 100 equipped with such locks.

The decoder system is able to retrieve these records from the key to provide an electronic audit trail of activity data that is uploadable and downloadable via a corresponding cloud-based software environment. For example, remote communication to the cloud may be facilitated via a communication module in the decoder to provide access to a communication network such as a 3GPP-compliant mobile data network (e.g. GPRS, EDGE, HSPA, LTE, 5G NR and other related technologies). The audit trail therefore provides access records indicating when the assembly 100 was accessed and by whom (e.g. determinable based on an identifier of the key issued to the user). This activity report can be sent to administrators in real-time for review and auditing purposes.

Keys issued to authorized users to access the assembly 100 may be programmed in real-time to permit or deny access to a particular lock. This programming may be done using the decoder installed within the service vehicle shortly prior to use, for example. The decoder may be configured to create a record at the time the key is programmed and removed from the decoder. Information recorded can include the user name, date, time, vehicle and GPS location (e.g. the programming location). The record can be uploaded to the cloud and then to an administrator's computer. Similarly, when the key is returned to the decoder, one or more of the user name, date, time, vehicle, GPS location, or other location-identifying information such as the address of the device, and service cover assembly identification is uploaded to the cloud and then to the administrator's computer. In some cases, the programming may permit a user access credentials to disengage the lock 400 only during a certain period of time. The foregoing access control system therefore enables administrators to grant and remove access rights as appropriate to maintain control and monitoring of the assembly 100. Such level of access control via key programming serves as another access barrier.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole.

1. A service cover assembly comprising:
a cover plate with a through-hole;
a main cylinder with a hollow interior attached to the cover plate and positioned to align the hollow interior with the through-hole;
a pinion gear system attached to the main cylinder, the pinion gear system being accessible and operable by a user of the service cover assembly through the through-hole and the hollow interior;
a plurality of securing rods operatively coupled to the pinion gear system; and
at least one access barrier disposed within the main cylinder to restrict access and operation of the pinion gear system through the through-hole.

2. The service cover assembly of claim 1, wherein the main cylinder comprises a lip portion that extends radially therefrom and abuts a first surface of the cover plate.

3. The service cover assembly of claim 2, wherein a portion of the main cylinder is inserted into the through-hole and positioned such that a first end of the main cylinder is flush with the second side of the cover plate.

4. The service cover assembly of claim 1, wherein one of the at least one access barrier is a tamper seal attachable to a first end of the main cylinder, and wherein the tamper seal covers a first opening of the main cylinder to restrict access to the hollow interior of the main cylinder and the pinion gear system through the through-hole.

5. The service cover assembly of claim 1, wherein one of the at least one access barrier is a lock disposed within the hollow interior of the main cylinder, the lock being secured within the hollow interior and immoveable therefrom in a locked state to restrict access to the pinion gear system through the through-hole and removable from the hollow interior in an unlocked state.

6. The service cover assembly of claim 5, wherein
the at least one access barrier further comprises a pattern cap positioned within the hollow interior of the main cylinder;
the pattern cap occupies a first chamber of the hollow interior proximal to a first opening of the main cylinder;
the lock occupies a second chamber of the hollow interior proximal to a second opening of the main cylinder; and
the pattern cap is secured to the first chamber to restrict access to the lock and the pinion gear system through the through-hole.

7. The service cover assembly of claim 6, wherein the second chamber is liquid tight and contains a heavy mineral oil to restrict the lock from exposure to moisture.

8. The service cover assembly of claim 7, wherein the liquid tight second chamber is maintained using O-ring seals.

9. The service cover assembly of claim 6, wherein the pattern cap is a liquid tight pattern cap that restricts movement of moisture from the first chamber to the second chamber.

10. The service cover assembly of claim 1 comprising an allen pattern gear disposed within the pinion gear system, the allen pattern gear being engageable with a corresponding tool to enable the user to operate the pinion gear system through the through-hole.

11. The service cover assembly of claim 10, wherein the corresponding tool is a splined mechanical drive shaft insertable into an opening of the allen pattern gear.

12. The service cover assembly of claim 1, wherein each of the plurality of securing rods is positionable between a secured and an unsecured position by operating the pinion gear system through the through-hole.

13. The service cover assembly of claim 12, wherein the plurality of securing rods in the secured position extends beyond a perimeter of the cover plate.

14. The service cover assembly of claim 12, wherein the plurality of securing rods in the secured position engage a corresponding receptacle of a service cover crown to secure the service cover to the crown.

15. The service cover assembly of claim 5, wherein the lock is an electro-mechanical lock operable using a programmable key to place the lock in the unlocked and locked states.

16. The service cover assembly of claim 15, wherein operation of the electro-mechanical lock is recorded to provide an audit trail.

17. The service cover assembly of claim 15, wherein the programmable key is programmable using a key captive device, the device being configured to generate access records indicating at least one of: a user name, programming date, programming time, programming location, service cover identification, and time of service cover access.

18. The service cover assembly of claim 1, wherein
an interior wall of the hollow interior of the main cylinder is threaded to receive a service cover assembly removal tool in screw-on engagement therewith; and
the service cover assembly is removable from a service cover crown by elevating the service cover therefrom.

19. A locking mechanism for securing a service cover to a corresponding service cover crown, the locking mechanism comprising:
a main cylinder with a hollow interior and respective first and second openings at a first end and a second end of the main cylinder, the main cylinder being attachable to the cover plate at the first end;
a pinion gear system attached to the second end of the main cylinder and accessible through the hollow interior and operable to position securing rods to secure the service cover to the service cover crown; and
at least one access barrier disposed within the main cylinder to restrict access and operation of the pinion gear system through the first opening.

20. The locking mechanism of claim 19, wherein the main cylinder comprises a lip portion that extends radially therefrom to attach the locking mechanism to the service cover.

21. The locking mechanism of claim 19 wherein one of the at least one access barrier is a tamper seal attachable to the first end of the main cylinder, and wherein the tamper seal covers the first opening of the main cylinder to restrict access to the hollow interior of the main cylinder and the pinion gear system through the first opening.

22. The locking mechanism of claim 19, wherein one of the at least one access barrier is a lock disposed within the hollow interior of the main cylinder, the lock being secured within the hollow interior and immoveable therefrom in a locked state to restrict access to the pinion gear system through the first opening and removable from the hollow interior in an unlocked state.

23. The locking mechanism of claim 22 wherein
the at least one access barrier further comprises a pattern cap positioned within the hollow interior of the main cylinder;
the pattern cap occupies a first chamber of the hollow interior proximal to the first opening of the main cylinder;
the lock occupies a second chamber of the hollow interior proximal to the second opening of the main cylinder; and
the pattern cap is secured to the first chamber to restrict access to the lock and the pinion gear system through the first opening.

24. The locking mechanism of claim 23, wherein the second chamber is liquid tight and contains a heavy mineral oil to restrict the lock from exposure to moisture.

25. The locking mechanism of claim 24, wherein the liquid tight second chamber is maintained using O-ring seals.

26. The locking mechanism of claim 23, wherein the pattern cap is a liquid tight pattern cap that restricts movement of moisture from the first chamber to the second chamber.

27. The locking mechanism of claim 19 comprising an allen pattern gear disposed within the pinion gear system, the allen pattern gear being engageable with a corresponding tool to enable a user to operate the pinion gear system through the first opening.

28. The locking mechanism of claim 27, wherein the corresponding tool is a splined mechanical drive shaft insertable into an opening of the allen pattern gear.

29. The locking mechanism of claim 22, wherein the lock is an electro-mechanical lock operable using a programmable key to place the lock in the unlocked and locked states.

30. The locking mechanism of claim 29, wherein operation of the electro-mechanical lock is recorded to provide an audit trail.

31. The locking mechanism of claim 29, wherein the programmable key is programmable using a key captive device, the device being configured to generate access records indicating at least one of: a user name, programming date, programming time, programming location, service cover identification, and time of service cover access.
